(19) United States
(12) Patent Application Publication
(10) Pub. No.: US 2009/0154448 A1
(43) Pub. Date: Jun. 18, 2009

(54) TERMINAL EQUIPMENT OF COMMUNICATION SYSTEM AND METHOD THEREOF

(75) Inventors: Seung-Hwan Lee, Seoul (KR); Won-Jae Cha, Seoul (KR); Sang-Jeom Lee, Seoul (KR)

Correspondence Address: PEARNE & GORDON LLP, 1801 EAST 9TH STREET, SUITE 1200, CLEVELAND, OH, 44114-3108, US

(73) Assignee: MIRACOM TECHNOLOGY CO., LTD, Sungnam-si, Gyunggi-do (KR)

(21) Appl. No.: 11/719,844

(22) PCT Filed: Oct. 20, 2005
(86) PCT No.: PCT/KR05/03496

§ 371 Date: May 21, 2007

(30) Foreign Application Priority Data
Nov. 23, 2004 (KR) 10-2004-0096493
Aug. 8, 2005 (KR) 10-2005-0072367

(51) Int. Cl. H04L 12/66; G10L 19/00

(52) U.S. Cl. 370/352; 704/201; 704/E19.001

(57) ABSTRACT

Disclosed is a transmitting and receiving apparatus and method in a communication system. The transmitting and receiving apparatus and method can provide a data service for exchanging user data including characters, images, computer files, messages, etc. as well as voice over a voice physical channel for providing a voice service in a wireless communication system including IS-95A/B, CDMA 1x, GSM and W-CDMA and in a communication system including a voice service for providing a VoIP service through a wired/wireless packet network. That is, the transmitting and receiving apparatus and method can provide a data service which transfers user data information while a voice service is provided or plays a game etc. during a call.

### TECHNICAL FIELD

The present invention relates to a transmitting and receiving apparatus and method for providing a peer-to-peer data service (PDS) that can transmit data information as well over a voice physical channel for providing a voice service in a communication system. In particular, the present invention relates to a transmitting and receiving apparatus and method in a mobile communication system for simultaneously exchanging various kinds of information between transmitting and receiving terminals by using a voice service physical channel which has been most widely used since a communication service was provided and for enabling the transmission of photographs or emoticons to a designation terminal while a voice service is provided.

### BACKGROUND ART

A communication service has been widely spread and used since it was first commenced in the late 20^{th} century. Especially, a radio communication service has grown at a rapid speed with the advantage of mobility, and a voice service based on the internet has steadily developed as the internet spreads all over the world with a rapid development of a very high-speed network, increasing a demand for providing a VoIP (Voice over Internet Protocol) service that provides a voice service through a current packet network by linking radio communication thereto.

The radio communication has required effort to obtain efficient voice traffic transmission over the air, and because of the high cost of channel resources for radio transmission, technologies for the compression and transmission of voice data over the air have been developed. Particularly, a compression technology for voice data and a wireless physical layer technology for radio transmission of the voice data are at the center of those technologies for the purpose of the best frequency efficiency and the best quality sensed by human beings, and the standardization of the wireless physical layer for providing a VoIP service has been actively conducted.

FIG. 1 is a conceptual view of a data transmitting and receiving apparatus in a communication system. A vocoder block 1 generates voice information and a data block 2 generates data information to transfer. In a transmitting procedure, among information produced through the vocoder block 1 and data block 2, the voice information is transferred over a voice physical channel for a voice service through a transmitter 4 of a transferring block 3, and the data information is transferred over a data physical channel for a data service, which is a separate channel from the voice physical channel, through the transmitter 4 of the transferring block 3.

In a receiving procedure, the voice information received through the voice physical channel from a receiver 5 of the transferring block 3 is transferred to the vocoder block 1, and the data information received through the data physical channel from the receiver 5 of the transferring block 3 is transferred to the data block 2. In this case, the voice information is a real-time basis, but the data information is not. Since the data block 2 have to have a link layer function for error compensation and error correction in order to guarantee the reliability of the data information, there is a limit to real-time voice and data information services.

In order to transmit or receive any information to or from other people under the state that voice service through a circuit service or a packet service is connected to a communication system, additional resources should be necessarily assigned irrespective of the amount of data information, thereby additionally using physical channel resources for an additional data service and thus bringing about the inefficiency of resources.

In providing a data service, a conventional technique has the following restrictions and problems.

First, if it is necessary to provide the same user with a voice service while a packet data service is served, the data service should be terminated in order to provide the voice service. In more detail, since the data service used until the voice service is demanded is terminated by the demand of the voice service, the final state of the data service cannot be maintained.

Second, if it is desired for the user to send data to a mobile terminal but not to a network server using the data service, since a “mobile terminated (MT) data service is not provided, an originating mobile terminal uploads the data to the network server by using the wireless packet data service. Then the network server sends information on an URL (Uniform Resource Locator) to a designation mobile terminal through a short message service (SMS). The designation mobile terminal which received the information on the URL accesses the corresponding URL by using the wireless packet data service and downloads the information uploaded by the originating mobile terminal. Therefore, there are many restrictions in providing a push service through the server.

Third, services are not satisfied when it is necessary to send idea or express emotion by using characters or emoticons in the case where it is difficult to express idea or emotion, for example, in public areas such as a library or theater or in a situation making a call with a deaf person.

### DISCLOSURE

### Technical Problem

Therefore, the present invention has been made to solve the above problems occurring in the current communication systems, and it is an object of the present invention to provide a data transmitting and receiving apparatus which can transmit and receive a plurality of items of data information within a bandwidth of a voice physical channel for providing a voice service, when two users transmit and receive necessary information in providing a voice service between mobile terminals in a wireless communication network, between VoIP terminals for providing a VoIP voice service using a wired/wireless packet network, and between a mobile terminal and a VoIP terminal.

It is another object of the present invention to solve the inefficiency of radio resources and a high cost, generated in the process of allocating an additional physical channel irrespective of the amount of data information in order to provide a packet data service in a current communication system.

To accomplish the above objects, according to the present invention, there is provided an apparatus for freely transmitting and receiving user data between users even during a voice service by transmitting and receiving a data frame conveying user data information including characters, images, computer files, messages, etc. as well as a voice frame over a voice physical channel for providing a voice service in a wireless communication system including IS (Interim Standard)-95A/B, CDMA (Code Division Multiple Access) 1×, GSM (Global System for Mobile Communications) and W-CDMA (Wideband-Code Division Multiple Access) and in a communication system including a voice service for providing a VoIP service through a wired/wireless packet network.

Technical Solution According to an aspect of the present invention, a transmitting and receiving apparatus comprises: a voice processing block for encoding voice into a voice frame to be transferred or decoding a received voice frame to output the decoded voice frame; a user data block for processing user data; a user data interfacing block for allocating a service identifier to the user data transferred from the user data block, demultiplexing the user data into user data segments of given sizes to transfer the user data segments to a PDS (Peer-to-Peer Data Service) processing block, assembling the user data segments transferred from the PDS processing block, interpreting the service identifier, and transferring the user data to the user data block; the PDS processing block for generating a PDS frame based on the voice frame transferred from the voice processing block, or on the voice frame and a data frame corresponding to the user data frame segment transferred from the user data interfacing block to transfer the PDS frame to an access physical layer block, and analyzing the PDS frame transferred from the access physical layer block to transfer the voice frame to the voice processing block or the user data segments to the user data block; and the access physical layer block for transmitting and receiving the PDS frame through a voice physical channel according to an access standard of a communication environment.

Preferably, the PDS processing block comprises: a PDS link layer for determining whether the voice frame can be multiplexed with the user data, detecting and restoring errors of the user data, and generating the data frame or a control frame from the user data segments; a PDS frame generating part for generating the PDS frame by multiplexing the voice frame with the data frame or control frame received from the PDS link layer; and a PDS frame analyzing part for analyzing the PDS frame received from the access physical layer, and demultiplexing the analyzed frame into the voice frame, the data frame or control frame, and transferring the demultiplexed frame.

It is preferable that the PDS link layer comprises: a multiplexing part for receiving an information value of the voice frame received from the voice processing block and determining whether the voice frame can be multiplexed with the user data; a downward transferring part for generating a data frame if user data segments exist in the transmission buffer of the user data interfacing block and, if necessary, generating a control frame if the user data segments do not exist, when it is decided by the multiplexing part that the voice frame can be multiplexed with the user data, and transferring the generated data frame or control frame to the PDS frame generator together with a determination result; and an upward transferring part for analyzing the data frame or control frame received from the PDS frame analyzing part, performing a control procedure if the control frame is received, and extracting the user data segments and transferring the user data segments to the user data interfacing block if the data frame is received.

The PDS frame generating part comprises: a generator for generating the PDS frame by multiplexing the data frame or control frame received from the PDS link layer with the voice frame received from the voice processing block; and a transferer for transferring the PDS frame generated from the generator to the access physical layer.

The PDS frame analyzing part comprises: a frame determiner for determining whether data received from the access physical layer block is a pure voice frame or not; a demultiplexing part for demultiplexing the PDS frame into the voice frame and the data frame or control frame if the data received from the physical layer block is decided to be not the pure voice frame; and a frame transferer for transferring the voice frame to the voice processing block and transferring the segmented data frame or control frame to the PDS link layer.

The information value is a value for a voice rate in the case of a variable rate voice encoding scheme corresponding to the standard of 3GPP2 which is a synchronous mobile telecommunications standards institute, including IS-95A/B and CDMA 1×. The information value is a value for a voice activity detector in the case of a voice encoding scheme corresponding to the standard of 3GPP which is an asynchronous mobile telecommunications standards institute, including GSM and W-CDMA. In providing a VoIP service, the information value is a value for a voice activity detector in the case of a codec scheme using the voice activity detector applied by 3GPP and a value for a voice rate in the case of a variable rate voice encoding scheme.

The user data interfacing block comprises: a determining part for determining whether data received from the user data block is user data or data for PDS service control and status management; an allocating part for allocating a service identifier to the user data when the data received from the user data block is decided to be the user data; a segmenting part for segmenting the user data to which the service identifier is allocated into user data segments each having a prescribed size; a processing part for processing parameters for a PDS service and data for control and status management when the data received from the user data block is decided to be the data for PDS service control and status management data; a transmission buffer for storing the segmented user data segments so as to be processed in the PDS processing block; and an assembling part for assembling the user data segments received from the PDS link layer and transferring the assembled user data segments to the user data block.

According to another aspect of the present invention, a method for transmitting data in a communication system comprises the steps of: encoding voice into a voice frame; generating a data frame based on user data; multiplexing the voice frame with the data frame to generate a PDS frame; and transmitting the PDS frame through a voice physical channel.

According to a further aspect of the present invention, a method for receiving data in a communication system comprises the steps of: receiving a PDS frame through a voice physical channel, the PDS frame including a voice frame and a data frame generated based on user data; segmenting the PDS frame into the voice frame and data frame; and recovering the user data based on the data frame.

### Advantageous Effects

The apparatus and method of present invention not only can easily transmit and receive user data without an additional device upon a request for various data services demanded increasingly in a communication system but easily provide a data service between transmitting and receiving apparatuses, thereby providing various services for data information transfer needed between voice service users. Thus the present invention is effective for an increase in the amount of information and time used by users.

Moreover, the apparatus and method of present invention can provide various services in addition to a VoIP service based on a monotonous voice service by transmitting and receiving much data information within a bandwidth of a voice physical channel for a voice service in a widely spread VoIP service, and can identically apply the various services provided to a wireless communication terminal to the VoIP service by linking wireless communication to a wired VoIP service.

### DESCRIPTION OF DRAWINGS

Further objects and advantages of the invention can be more fully understood from the following detailed description taken in conjunction with the accompanying drawings in which:

FIG. 1 is a conceptual view of a transmitting and receiving apparatus of a conventional communication;

FIG. 2 is a view illustrating the configuration of an apparatus including a PDS processing block according to an embodiment of the present invention;

FIG. 3 is a view illustrating the configuration of a user data interfacing block according to an embodiment of the present invention;

FIG. 4 is a view illustrating the configuration of the PDS processing block according to an embodiment of the present invention;

FIG. 5 is a view illustrating the structure of a PDS frame according to an embodiment of the present invention;

FIGS. 6 and 7 are flow charts illustrating the transmitting and receiving processes of the user data interfacing block according to an embodiment of the present invention; and

FIGS. 8 and 9 are flow charts illustrating the transmitting and receiving processes of the PDS processing block according to an embodiment of the present invention.

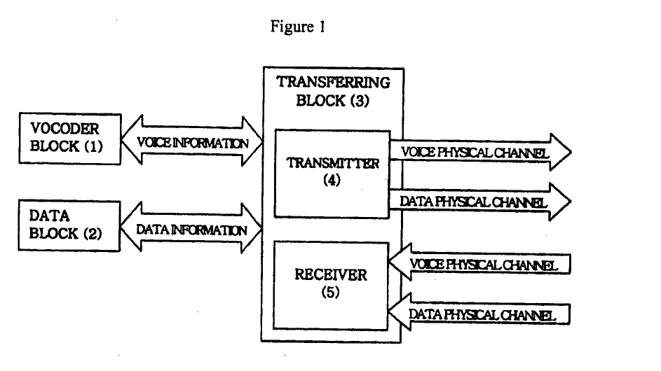

### BEST MODE

A transmitting and receiving apparatus of a communication system according to the present invention includes an access physical layer 70 with a unique function of the transmitting and receiving apparatus, a voice processing block 20 for encoding voice into a voice frame and decoding a received voice frame, a PDS processing block 40, a user data block 10, and a user data interfacing block 30. If there is user data 100 including characters, images, computer files, messages, etc. to be sent through the transmitting and receiving apparatus during a voice service, the PDS processing block 40 multiplexes the user data 100 including a PDS identifier with a voice frame during a period of time while a user does not talk and transmits a PDS frame to the access physical layer block 70. Contrarily, the PDS processing block 40 demultiplexes the PDS frame received from the access physical layer block 70 into a voice frame and user data, and transmits the voice frame and the user data to the voice processing block 20 and the user data block 10, respectively. The user data interfacing block 30 performs an interfacing function between the user data block 10 and the PDS processing block 40.

A preferred embodiment of the present invention will be described herein below with reference to the accompanying drawings.

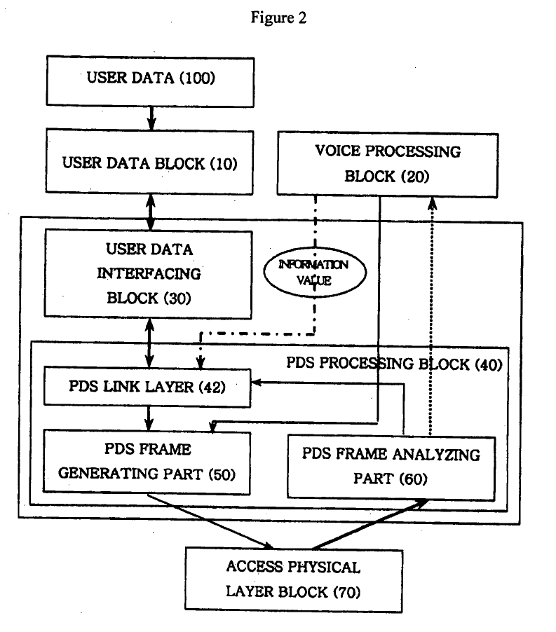

FIG. 2 illustrates the configuration of a transmitting and receiving apparatus including a PDS processing block according to the present invention.

Referring to FIG. 2, a user data block 10 processes user data 100 by using a wireless internet platform or user interface of the transmitting and receiving apparatus. The user data block 10 transmits the user data 100 entered by a user through an input device to a user data interfacing block 30, and receives the user data 100 from the user data interfacing block 30 to transmit the user data 100 to a user through an output device.

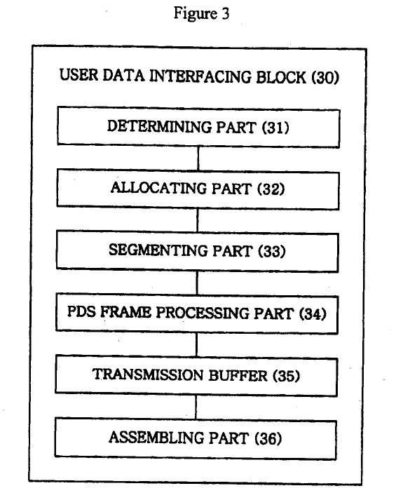

The configuration of the user data interfacing block 30 is illustrated in FIG. 3. A determining part 31 determines whether data received from the user data block 10 is the user data 100 or data for PDS service control and status management. An allocating part 32 allocates a service identifier to the user data 100 when the data received from the user data block 10 is determined to be the user data. A segmenting part 33 segments the user data to which the service identifier is allocated into user data segments 102 each having a prescribed size. A processing part 34 processes parameters for a PDS service and data for control and status management when the data received from the user data block 10 is decided to be data for PDS service control and status management data.

A transmission buffer 35 stores the segmented user data segments 102 so as to be processed in the PDS processing block 40. An assembling part 36 assembles the user data segments 102 received from the PDS processing block 40 and transfers the assembled user data 100 to the user data block 10.

The user data interfacing block 30 constructed as described above allocates a service identifier to the user data 100 received from the user data block 10 and segments the user data 100 into the user data segments 102 of sizes which can be accommodated in the access physical layer block 70 to transfer the user data segments 102 to the PDS processing block 40. Alternatively, the user data interfacing block 30 assembles the user data segments 102 received from the PDS processing block 40 into the user data 100, interprets the service identifier, and transfers the user data 100 to the user data block 10.

A voice processing block 20 transfers a voice frame 108, and an information value for a voice rate or for a voice activity detector (VAD) to the PDS processing block 40. The voice frame 108 is generated by encoding voice data according to a scheme recommended by 3GPP (Third Generation Partnership Project) and 3GPP2. The information value for a voice rate is applied to the case of a variable rate voice encoding scheme corresponding to the standard of 3GPP2 which is a synchronous mobile telecommunications standards institute, including IS-95A/B and CDMA 1×. The information value for the VAD is applied to the case of a voice encoding scheme corresponding to the standard of 3GPP which is an asynchronous standards institute, including GSM and W-CDMA. Various kinds of voice codecs may be applied in providing a VoIP service. If the applied codec is a variable rate scheme, the voice processing block 20 transfers the information value for the voice rate to the PDS processing block 40, and if it is a codec using the VAD adopted by 3GPP, the voice processing block 20 transfers the information value for the VAD to the PDS processing block 40.

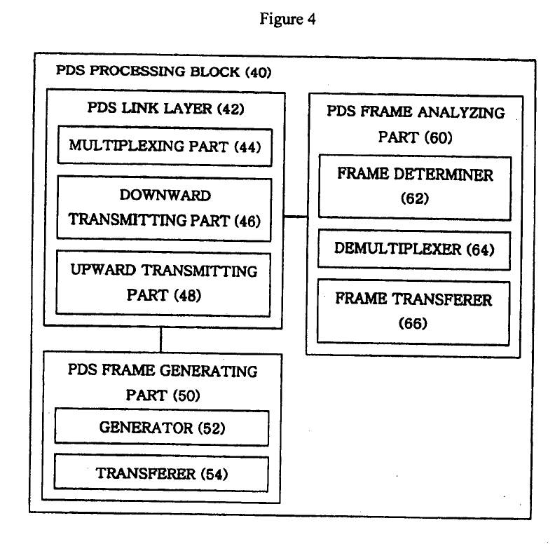

The PDS processing block 40 includes, as shown in FIG. 4, a PDS link layer 42, a PDS frame generating part 50 and a PDS frame analyzing part 60. Upon transference of the user data 100, the PDS processing block 40 multiplexes the user data 100 received from the user data interfacing block 30 with the voice frame received from the voice processing block 20, thereby generating a PDS frame 110.

Upon receipt of the user data 100, the PDS processing block 40 demultiplexes the PDS frame 110 received from the access physical layer block 70, and transfers the user data 100 and the voice frame 108 to the user data block 10 and the voice processing block 20, respectively, through the user data interfacing block 30. If the PDS frame 110 received from the access physical layer block 70 is a voice frame which is not multiplexed with the user data segments 102, the PDS processing block 40 transfers the PDS frame to the voice processing block 20 without any further processing.

Respective elements of the PDS processing block 40 are shown in FIG. 4. A PDS link layer 42, including a multiplexing part 44, a downward transmitting part 46 and an upward transmitting part 48, is in charge of user data error detecting and retransmitting functions and a link layer function such as sequential transmission of the user data 100.

In the case of a variable rate voice encoding scheme corresponding to the standard of 3GPP2 which is a synchronous mobile telecommunications standards institute, including IS-95A/B and CDMA 1×, the multiplexing part 42 receives an information value for a voice rate from the voice processing block 20 and determines whether the voice frame can be multiplexed with the user data 100. Alternatively, in the case of a voice encoding scheme corresponding to the standard of 3GPP which is an asynchronous standards institute, including GSM and W-CDMA, the multiplexing part 44 receives an information value of a VAD and determines whether the voice frame can be multiplexed with the user data 100.

If it is decided by the multiplexing part 44 that the voice frame can be multiplexed with the user data, the downward transferring part 46 generates the data frame 104 when the user data segments 102 exist in the transmission buffer 35 of the user data interfacing block 30, and generates, if necessary, the control frame 106 when the user data segments 102 do not exist. Then the downward transferring part 46 transfers the generated data frame 104 or control frame 106 to the PDS frame generating part 50 together with a determination result.

The upward transferring part 48 analyzes the data frame 104 or the control frame 106 received from the PDS frame analyzing part 60. If the control frame 106 is received, the upward transferring part 48 performs a control procedure. If the data frame 104 is received, the upward transferring part 48 extracts the user data segments 102 from the data frame 104 and transfers the user data segments 102 to the user data interfacing block 30.

The PDS frame generating part 50 includes a generator 52 for generating PDS frames and a transferer 54 for transferring respective frames.

The generator 52 multiplexes the data frame or control frame received from the PDS link layer 42 with the voice frame received from the voice processing block 20, generating the PDS frame 110.

The transferer 54 considers the PDS frame generated from the generator 52 and the voice frame 108 in which the data frame 104 or control frame 106 is not multiplexed as the PDS frame 110 and transfers the PDS frame 110 to the access physical layer block 70.

The PDS frame analyzing part 60 includes a frame determiner 62, a demultiplexer 64 and a frame transferer 66.

The frame determiner 62 determines whether data received from the access physical layer block 70 is a pure voice frame 108 or the PDS frame 110. The demultiplexer 64 demultiplexes the PDS frame 110 into the voice frame 108 and the data frame 104 or control frame 106 if data received from the access physical layer block 70 is decided to be the PDS frame 110.

The frame transferer 66 transfers the demultiplexed data frame 104 or control frame 106 to the PDS link layer 42 and transfers the voice frame 108 to the voice processing block 20.

The access physical layer block 70 links a physical channel for providing a voice service. The access physical layer block 70 transmits to a communication system a processing result of the PDS frame generating part 50 for multiplexing the voice frame 108 processed by the voice processing block 20 with the user data segments 102 received from the user data block 10. Moreover, the access physical layer block 70 transfers the PDS frame 110 received from the communication system to the PDS frame analyzing part 60 so as to demultiplex the PDS frame 110 into the voice frame 108 and the data frame 104 or control frame 106.

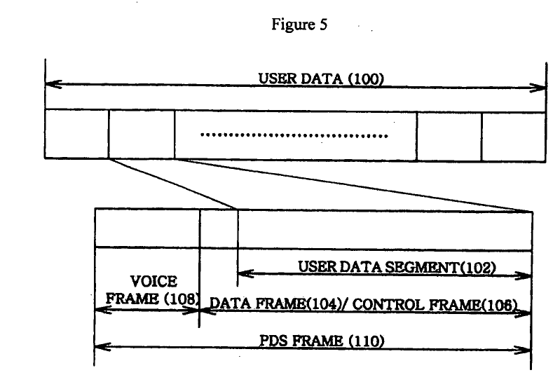

FIG. 5 illustrates the structure of the PDS frame 110 according to the present invention. The PDS frame 110 consists of the voice frame 108, and the data frame 104 or control frame 106 generated by the PDS processing block 40.

The data frame 104 includes the user data segments 102, and control data added by the PDS link layer 42 to identify a frame and check errors. The control frame 106 is in charge of the control of a PDS link and includes the control data of the PDS link layer 42 of the PDS processing block 40.

The user data segments 102 are data segmented from the user data 100 into segments of sizes which can be accommodated in the access physical layer block 70.

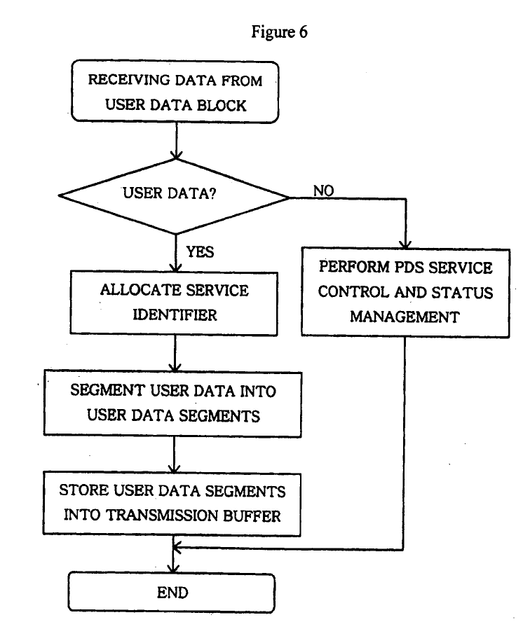

FIG. 6 is a flow chart illustrating a process for transferring, in the user data interfacing block 30, the user data 100 received from the user data block 10 to the PDS processing block 40.

Upon receiving data from the user data block 10, the user data interfacing block 30 determines whether the received data is the user data 100 or data for the control of the PDA processing block 40. If the received data is the user data 100, the user data interfacing block 30 allocates a service identifier and segments the user data into segments of sizes which can be accommodated in the access physical layer block 70 to generate the user data segments 102.

The user data interfacing block 30 stores the user data segments 102 in the transmission buffer 35 and completes a unit procedure. Then the user data interfacing block 30 waits for data received from the user data block 10. If the received data is data for the control of the PDS processing block 40, the user data interfacing block 30 performs PDS service control and status management and then waits for data received from the user data block 10.

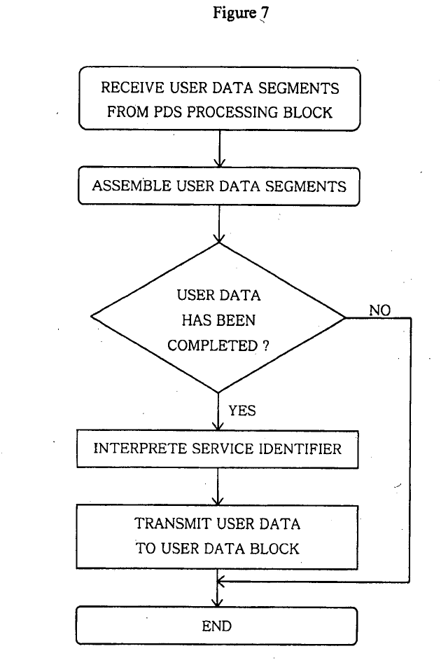

FIG. 7 is a flow chart illustrating a process of processing, in the user data interfacing block 30, the user data segments 102 received from the PDS processing block 40 and transferring the processed user data segments to the user data block 10.

The user data interfacing block 30 assembles the user data segments 102 received from the PDS processing block 40 in order to restore the user data segments 102 to the original user data 100. If the last user data segments constituting one user data 100 is received and the user data segments 102 are assembled to the user data 100, the user data interfacing block 30 interprets a service identifier contained in the completed user data 100 and transfers the user data 100 to the user data block 10. Then a unit procedure is ended.

While the user data segments 102 are assembled, if the user data is not completed, the user data interfacing block 30 waits for the next user data segments 102, completing a unit procedure.

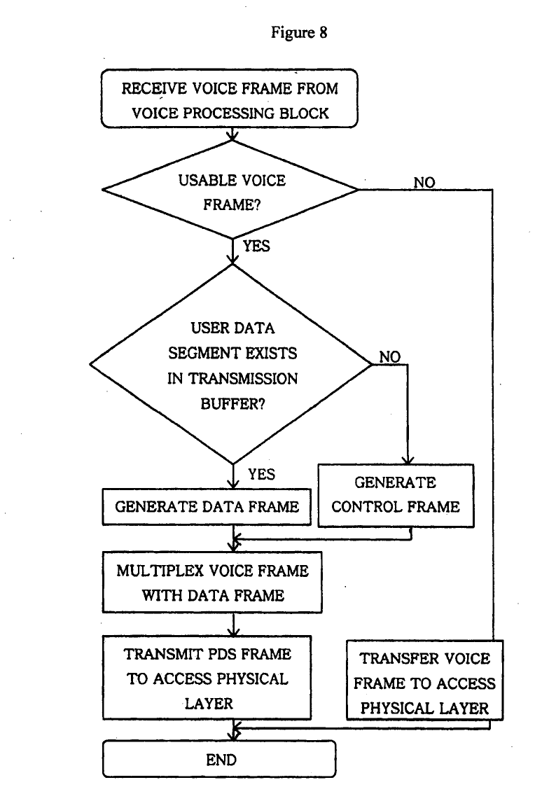

FIG. 8 is a flow chart illustrating a process of generating, in the PDS processing block 40, the PDS frame 110 by referring to the voice frame 108 received from the voice processing block 20 and to the transmission buffer 35 in which the user data segments 102 received from the user data interfacing block 30 are stored and transferring the PDS frame 110 to the access physical layer block 70.

Every period the voice frame 108 is received from the voice processing block 20, the PDS processing block 40 determines whether the received voice frame 108 is a usable voice frame. If the received voice frame is not a full rate in the case of a variable rate voice encoding scheme corresponding to the standard of 3GPP2, and if the received voice frame is decided to be a silence by an information value of a VAD in the case of a voice encoding scheme corresponding to the standard of GSM and 3GPP, the PDS processing block 40 considers the received voice frame as a usable voice frame 108.

If it is determined that there is no voice to transfer by an information value for a voice rate when an applied codec in providing a VoIP service is a variable rate scheme and by an information value of a VAD when a codec uses the VAD applied by 3GPP, the PDS processing block 40 considers the received voice frame as a usable voice frame 108.

If the received voice frame is considered as an available voice frame 108, the PDS processing block 40 checks if the transmission buffer 35 stores the user data segments 102. If the user data segments 102 exist, the PDS processing block 40 generates the data frame 104 including the user data segments 102.

The PDS processing block 40 multiplexes the data frame 104 with the voice frame 108 to generate the PDS frame 110 and transfers the PDS frame 110 to the access physical layer block 70, completing a unit procedure. Thereafter, the PDS Processing block 40 waits for the voice frame of the next period.

If the received voice frame 108 is not available, the PDS processing block 40 considers the voice frame 108 as the PDS frame 110 and transfers the voice frame 108 to the access physical layer block 70, leading to a completion of a unit procedure.

Even though the available voice frame is received, if the user data segments 102 do not exist in the transmission buffer 35, the PDS processing block 40 generates, if necessary, the control frame 106 including control data for controlling the PDS processing block 40 or detecting and restoring errors in order to maintain link establishment for providing a PDS service between transmitting and receiving apparatuses, and generates the PDS frame 110 by multiplexing the control frame 106 with the voice frame 108, proceeding to the next procedure.

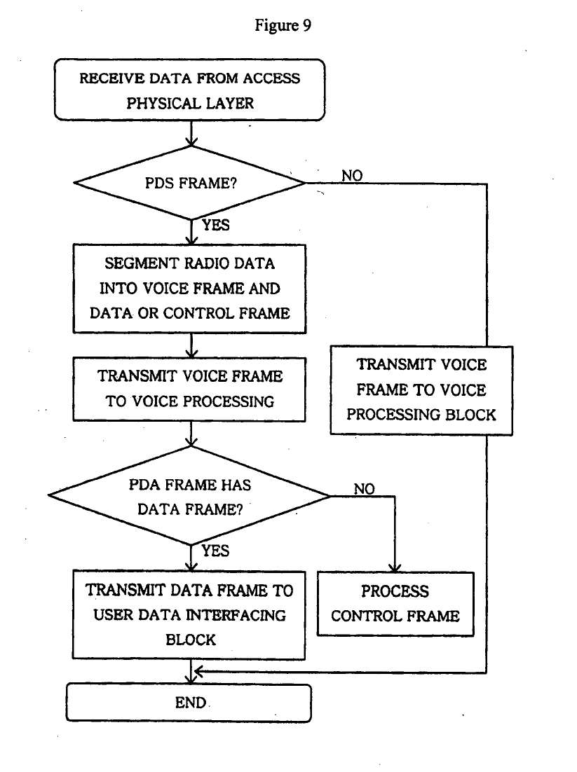

FIG. 9 is a flow chart illustrating a process of processing, in the PDS processing block 40, the PDS frame 110 received from the access physical layer block 70 and transferring a processed result to the user data interfacing block 30 and the voice processing block 20.

Every period the radio data is received from the access physical layer block 70 for providing a voice service, the PDS processing block 40 determines whether the radio data is a pure voice frame 108 or a PDS frame 110 in which the user data is multiplexed. If the radio data is decided to be the PDS frame 110, the PDS processing block 40 demultiplexes the radio data into the voice frame 108, and the data frame 104 or control frame 106 and transfers the voice frame 108 to the voice processing block 20.

The PDS processing block 40 determined whether the PDS frame has a data frame. If the PDS frame includes the data frame, the PDS processing block 40 transfers the data frame 104 to the use data interfacing block 30. If the PDS frame includes the control frame 106, the control frame 106 is processed in the PDS link layer 42 and a unit procedure is completed.

Meanwhile, if the radio data received from the access physical layer block 70 is a pure voice frame 108 with which the data frame or the control frame is not multiplexed, the PDS processing block 40 transfers the voice frame to the voice processing block 20, leading to a completion of a unit procedure.

### INDUSTRIAL APPLICABILITY

As described above, the inventive transmitting and receiving apparatus can transmit and receive data as well as voice by using a voice physical channel and thus it is economical since there is no need to allocate an additional physical channel for data transmission and reception. Further, it is possible to provide a free call to those who require a call not by voice but by data information, such as a person who is hard of hearing or a person who suffers speech impediments, and it is possible for those people to communicate when they face an emergency.

Moreover, since the inventive apparatus provides a mobile terminated (MT) data service, it can be applied to remote status monitoring and information collection of industrial facilities, public facilities etc.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A transmitting and receiving apparatus, comprising:
a voice processing block for encoding voice into a voice frame to transfer the encoded voice frame or decoding a received voice frame to output the decoded voice frame;
a user data block for processing user data;
a user data interfacing block for allocating a service identifier to the user data transferred thereto from the user data block, demultiplexing the user data into user data segments of given sizes to transfer the user data segment to a PDS (Peer-to-Peer Data Service) processing block, assembling the user data segment transferred from the PDS processing block, interpreting the service identifier, and transferring the user data to the user data block;
the PDS processing block for generating a PDS frame based on the voice frame transferred from the voice processing block, or on the voice frame and a data frame corresponding to the user data frame segment transferred from the user data interfacing block to transfer the PDS frame to an access physical layer block, and analyzing the PDS frame transferred from the access physical layer block to transfer the voice frame to the voice processing block or the user data segments to the user data block; and
the access physical layer block for transmitting and receiving the PDS frame through a voice physical channel according to an access standard of a communication environment.

2. The transmitting and receiving apparatus as claimed in claim 1, wherein the PDS processing block comprises:
a PDS link layer for determining whether the voice frame can be multiplexed with the user data, detecting and restoring errors of the user data, and generating the data frame or a control frame from the user data segments;
a PDS frame generating part for generating the PDS frame by multiplexing the voice frame with the data frame or control frame received from the PDS link layer; and
a PDS frame analyzing part for analyzing the PDS frame received from the access physical layer, and demultiplexing the analyzed frame into the voice frame, the data frame or control frame, and transferring the demultiplexed frame.

3. The transmitting and receiving apparatus as claimed in claim 2, wherein the PDS link layer comprises:
a multiplexing part for receiving an information value of the voice frame received from the voice processing block and determining whether the voice frame can be multiplexed with the user data;
a downward transferring part for generating a data frame if user data segments exists in the transmission buffer of the user data interfacing block and, if necessary, generating a control frame if the user data segments do not exist, when it is decided by the multiplexing part that the voice frame can be multiplexed with the user data, and transferring the generated data frame or control frame to the PDS frame generator together with a determination result; and
an upward transferring part for analyzing the data frame or control frame received from the PDS frame analyzing part, performing a control procedure if the control frame is received, and extracting the user data segments and transferring the user data segments to the user data interfacing block if the data frame is received.

4. The transmitting and receiving apparatus as claimed in claim 2, wherein the PDS frame generating part comprises:
a generator for generating the PDS frame by multiplexing the data frame or control frame received from the PDS link layer with the voice frame received from the voice processing block; and
a transferer for transferring the PDS frame generated from the generator to the access physical layer.

5. The transmitting and receiving apparatus as claimed in claim 2, wherein the PDS frame analyzing part comprises:
a frame determiner for determining whether data received from the access physical layer block is a pure voice frame or not;
a demultiplexing part for demultiplexing the PDS frame into the voice frame and the data frame or control frame if the data received from the physical layer block is decided to be not the pure voice frame; and
a frame transferrer for transferring the voice frame to the voice processing block and transferring the segmented data frame or control frame to the PDS link layer.

6. The transmitting and receiving apparatus as claimed in claim 3, wherein the information value is a value for a voice rate in the case of a variable rate voice encoding scheme corresponding to the standard of 3GPP2 (Third Generation Partnership Project 2) which is a synchronous mobile telecommunications standards institute, including IS-95A/B and CDMA 1×x.

7. The transmitting and receiving apparatus as claimed in claim 3, wherein the information value is a value for a voice activity detector in the case of a voice encoding scheme corresponding to the standard of 3GPP (Third Generation Partnership Project) which is an asynchronous mobile telecommunications standards institute, including GSM and W-CDMA.

8. The transmitting and receiving apparatus as claimed in claim 3, wherein the information value is a value for a voice activity detector in the case of a codec scheme using the voice activity detector applied by 3GPP (Third Generation Partnership Project) in providing a VoIP (Voice over Internet Protocol) service and a value for a voice rate in the case of a variable rate voice encoding scheme.

9. The transmitting and receiving apparatus as claimed in claim 1, wherein the user data interfacing block comprises:
a determining part for determining whether data received from the user data block is user data or data for PDS service control and status management;
an allocating part for allocating a service identifier to the user data when the data received from the user data block is decided to be the user data;
a segmenting part for segmenting the user data to which the service identifier is allocated into user data segments each having a prescribed size;
a processing part for processing parameters for a PDS service and data for control and status management when the data received from the user data block is decided to be the data for PDS service control and status management data;
a transmission buffer for storing the segmented user data segments so as to be processed in the PDS processing block; and
an assembling part for assembling the user data segments received from the PDS link PDS processing block and transferring the assembled user data segments to the user data block.

10. A method for transmitting and receiving data in a communication system, comprising the steps of:
encoding voice into a voice frame;
generating a data frame based on user data;
multiplexing the voice frame with the data frame to generate a PDS frame; and
transmitting the PDS frame through a voice physical channel.

11. A method for transmitting and receiving data in a communication system, comprising the steps of:
receiving a PDS frame through a voice physical channel, the PDS frame including a voice frame and a data frame generated based on user data;
segmenting the PDS frame into the voice frame and data frame; and
recovering the user data based on the data frame.
